(19) United States
(12) Patent Application Publication
(10) Pub. No.: US 2015/0293377 A1
(43) Pub. Date: Oct. 15, 2015

(54) METHOD FOR PROVIDING AN OPTICAL LENS

(71) Applicant: ESSILOR INTERNATIONAL (COMPAGNIE GENERALE D'OPTIQUE), Charenton-le-pont (FR)

(72) Inventors: Pascal Allione, Charenton-le-Pont (FR); Pauline Colas, Charenton-le-Pont (FR); Guillaume Broutin, Charenton-le-Pont (FR); Jean Sahler, Charenton-le-Pont (FR)

(21) Appl. No.: 14/438,629

(22) PCT Filed: Oct. 24, 2013
(86) PCT No.: PCT/EP2013/072305

§ 371 Date: Apr. 26, 2015

(30) Foreign Application Priority Data
Oct. 26, 2012 (EP) 12306336.4

(51) Int. Cl. G02C 7/02

(52) U.S. Cl. CPC G02C 7/028; G02C 7/027

(57) ABSTRACT

A method of data processing for providing an optical lens is disclosed, the method being implemented by computer means. The method comprises a determining step during which an association between an elements subset of an elements set and a properties collection is determined, the elements subset comprising at least two elements. And, the method comprises a storing step during which data related to the elements subset and the associated properties collection is stored, the elements subset related data describing the elements subset (SS₁, SS₂) from a list of primitive elements and a list of set operators.

### CROSS REFERENCE TO RELATED APPLICATIONS

This application is a U.S. national stage application of International Application No. PCT/EP2013/072305 filed Oct. 24, 2013, which claims the benefit of priority to EP Application No. 12306336.4, filed Oct. 26, 2012; the entirety of each of said applications is incorporated herein by reference.

### FIELD OF THE INVENTION

The invention described herein relates to a method of data processing for providing an optical lens.

### BACKGROUND

The discussion of the background of the invention herein is included to explain the context of the invention. This is not to be taken as an admission that any of the material referred to was published, known or part of the common general knowledge at the priority date of any of the claims.

Optical lenses are commonly used for correcting many different types of vision deficiencies of a wearer of the optical lens. These include defects, such as near-sightedness (myopia), far-sightedness (hypermetropia), astigmatism, and defects in near-range vision usually associated with aging (presbyopia).

Today, an increasing number of parameters are taken into account when providing an optical lens, and association rules are used to associate these parameters to each other. Consequently, an increasing number of data has to be stored and managed for providing an optical lens.

However, the current methods of data storing and processing are not adapted to deal with a great number of data, and do not permit, for instance, management of some continuous data set.

Consequently, there is a need for methods for improving the storing and processing of discrete and continuous data set for providing an optical lens.

### SUMMARY

One object described herein is to provide methods of data processing for providing an optical lens that does not present the drawbacks mentioned hereinabove.

To this end, described herein is a method of data processing to provide an optical lens. The method is implemented by computer means and comprises:
a determining step during which an association between an elements subset of an elements set and a properties collection is determined, the elements subset comprising at least two elements, and
a storing step during which data related to the elements subset and the associated properties collection is stored, the elements subset related data describing the elements subset from a list of primitive elements and a list of set operators.

The elements set may belong to an N-dimensional space, N being an integer. Then, the method may comprise a retrieving step during which the elements subset is retrieved from an element of the N-dimensional space, the properties collection being retrieved from the stored elements subset data.

In other embodiments, the method comprises a retrieving step during which the elements subset is retrieved from the stored properties collection data, or during which the properties collection is retrieved from the stored elements subset data.

For example, the list of primitive elements may comprise one or several elements among singleton, ball, parallelepiped, polygon, convex polygon, pixelated polygon, simplex, interval, segment, and grid, and the list of set operators may comprise one or several elements among union, intersection, Cartesian product, rotation, translation, homothetic transformation, and exclusion. The lists above are to be interpreted according to the mathematical definitions.

The properties collection may be related to wearer parameters associated with the wearer of the optical lens, to lens parameters associated with the optical lens, to process parameters for manufacturing the optical lens, to target optical parameters for computing the optical lens, to environmental parameters associated with an environment of the wearer of the optical lens, to computing type parameters associated with a type of computing to be used for computing the optical lens, and/or to frame parameters associated with the frame receiving the optical lens.

For example, the target optical parameters related properties collection may comprise one or several properties among an inset of the optical lens, a progressive length of the optical lens, and a design feature of the optical lens.

According to some embodiments, the method comprises a selecting step during which a semi-finished lens to be used for the optical lens is selected based on the retrieved properties collection.

According to other embodiments, the method comprises a calculating step during which the optical lens adapted to the wearer is calculated based on the retrieved properties collection.

According to still further embodiments, the method comprises a setting step during which machining parameters to be used for the optical lens machining are set based on the retrieved properties collection.

The wearer parameters related properties collection may comprise one or several properties among a reading distance of the wearer, a master eye of the wearer, a prescription data of the wearer, a positioning data of the lens relative to the wearer, and a physiological data of the wearer.

The lens parameters related properties collection may comprise one or several properties among a base curve data of the finished surface of the semi-finished lens, a diameter data of the semi-finished lens, and a design data of the optical lens.

Further described herein is a computer program product comprising one or more stored sequences of instructions that are accessible to a processor and which, when executed by the processor, causes the processor to carry out the steps of the method.

Still further, described herein is a computer readable medium carrying one or more sequences of instructions of the computer program product.

Unless specifically stated otherwise, as apparent from the following discussions, it is appreciated that throughout the specification discussions utilizing terms, such as “computing”, “calculating”, “generating”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments presented herein may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments presented herein are not described with reference to any particular programming language. It will be appreciated that a variety of programming languages may be used to implement the teachings of the inventions as described herein.

### BRIEF DESCRIPTION OF THE DRAWINGS

Non limiting embodiments will now be described with reference to the accompanying drawing, wherein:

FIG. 1 is a flow chart showing steps of a method of data processing for providing an optical lens according to various embodiments;

FIG. 2 is a representation of a 2-dimensional space comprising an elements set, the elements set comprising elements subsets respectively associated to properties collections;

FIG. 3 is a representation of an elements subset to be described from a list of primitive elements and a list of set operators; and

FIGS. 4 to 6 represent examples of use of the method of data processing for providing an optical lens.

### DESCRIPTION

Elements in the figures are illustrated for simplicity and clarity and have not necessarily been drawn to scale. For example, the dimensions of some of the elements in the figures may be exaggerated relative to other elements to help improve the understanding of the embodiments of the present invention.

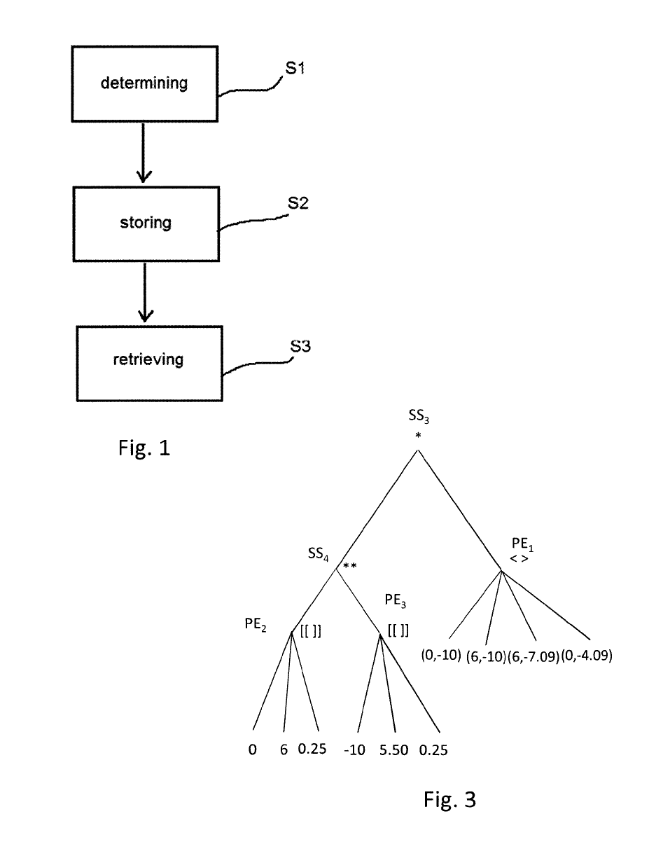

FIG. 1 shows steps of a method of data processing for providing an optical lens according to an embodiment described herein. The method is implemented by computer means. According to the illustrated embodiment, the method comprises:
a determining step S1,
a storing step S2, and
a retrieving step S3.

During the determining step S1, an association is determined between an elements subset SS₁, SS₂ of an elements set S and a properties collection PC₁, PC₂. The elements set S belongs to an N-dimensional space, N being an integer higher than 0. The elements set S may be a continuous set or a discrete set. The association is determined by using a predetermined association rule.

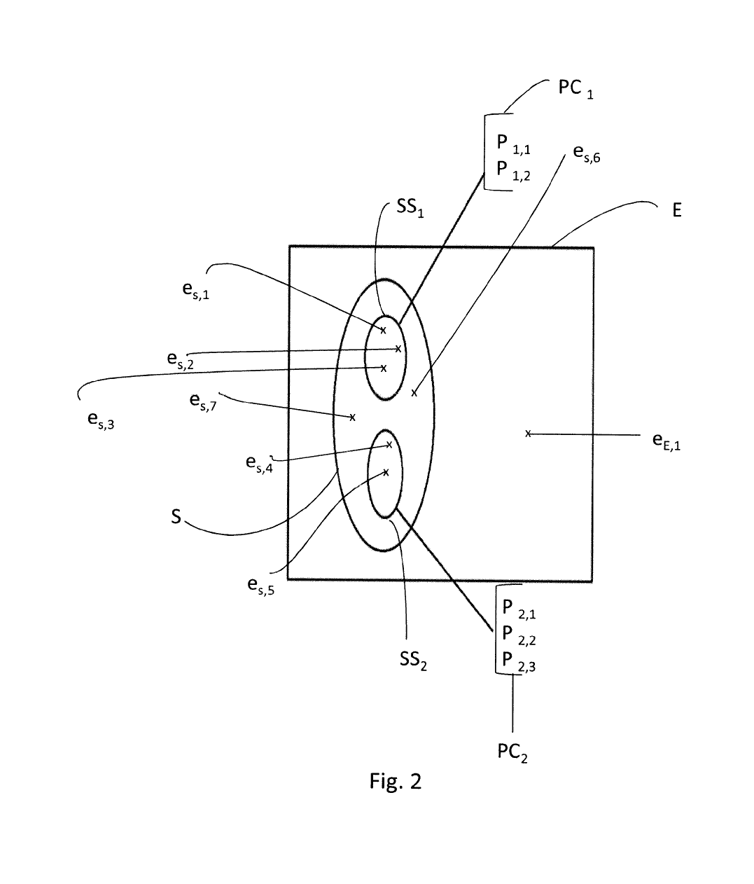

For instance, FIG. 2 represents a 2-dimensional space E comprising an elements set S comprising elements e_{S,i}, with 1≦i≦M_{S}, M_{S} being an integer strictly higher than 1. FIG. 2 shows seven elements e_{S,1} to e_{S,7} in the set S, but the number M_{S} of elements is not limited and may be infinite when the set S is a continuous set. A first elements subset SS₁ of the elements set S is defined as comprising elements e_{SS1,j}, with 1≦j≦M_{SS1}, M_{SS1} being an integer such as 1<M_{SS1}≦M_{S}. In the example represented, the first elements subset SS₁ comprises three elements e_{SS1,1}=e_{S,1}=e_{SS1,2}=e_{S,2} and e_{SS1,3}=e_{S,3}. The elements subset SS₁ is associated with a first properties collection PC₁ comprising two properties P_{1,1} and P_{1,2}.

Several associations may be determined between elements subsets SS₁, SS₂ of the elements set S and respective properties collections PC₁, PC₂. For instance, a second element subset SS₂ of the elements set S may be defined as comprising elements e_{SS2,k}, with 1≦k≦M_{SS2}, M_{SS2} being an integer such as 1<M_{SS2}≦M_{S}. In the example represented, the second elements subset SS₂ comprises two elements e_{SS2,1}=e_{S,4} and e_{SS2,2}=e_{S,5}. The second element subset SS₂ is associated with a second properties collection PC₂.

The properties collections PC₁, PC₂ associated with different elements subsets SS₁, SS₂ of the elements set S may comprise different number and/or type of properties. For example, the second properties collection PC₂ may comprise three properties P_{2,1}, P_{2,2} and P_{2,3}.

The elements e_{S,i} of the elements set S may be related to wearer parameters associated with the wearer of the optical lens, to lens parameters associated with the optical lens, to process parameters for manufacturing the optical lens, to target optical parameters for computing the optical lens, to environmental parameters associated with an environment of the wearer of the optical lens, to computing type parameters associated with a type of computing to be used for computing the optical lens, and/or to frame parameters associated with the frame receiving the optical lens.

Similarly, the properties P of the properties collections PC₁, PC₂ may be related to wearer parameters associated with the wearer of the optical lens, to lens parameters associated with the optical lens, to process parameters for manufacturing the optical lens, to target optical parameters for computing the optical lens, to environmental parameters associated with an environment of the wearer of the optical lens, to computing type parameters associated with a type of computing to be used for computing the optical lens, and/or to frame parameters associated with the frame receiving the optical lens.

The wearer parameters may comprise, for instance, a reading distance of the wearer, a master eye of the wearer, a prescription data of the wearer, a positioning data of the lens relative to the wearer, and a physiological data of the wearer.

A prescription data is a set of optical characteristics, such as spherical power, cylindrical power, cylinder axis, addition power, and prescribed prism, determined by an ophthalmologist in order to correct the vision defects of the wearer.

The lens parameters may comprise, for instance, a base curve data of the finished surface of a semi-finished lens, a diameter data of the semi-finished lens, and a design data of the optical lens.

A design data designates the features of the lens, which are not directly determined by the wearer parameters. In other words, the design data designates the set of parameters, except here above mentioned wearer parameters, for defining an optical function of the lens, for instance a field of view width, and an astigmatic gradient maximum. Each ophthalmic lens manufacturer has its own designs. Design data is disclosed, for instance, in EP 0 911 673, EP 0 911 672, U.S. Pat. No. 5,488,442, EP 1 327 175 and EP 1 328 839.

The process parameters may comprise, for instance, an indication related to the machine(s) or tool(s) to be used for manufacturing the optical lens. The machine(s) or tool(s) to be used may in particular depend on the prescription and on the optical lens position in the range.

The optical lenses are usually determined by using an optical optimization computing, which is performed from an initial lens and a target lens. Target optical parameters are then used for computing the optical lens. The target optical parameters may comprise, for instance, an inset of the optical lens, a progressive length of the optical lens, and a design feature of the optical lens.

The environmental parameters are related to an average environment of the wearer of the optical lens. For instance, the environmental parameters may comprise an indication that the optical lens is to be used for reading, for watching television, or for using a computer. The environment of the wearer may be defined by associating a target object point with each direction of viewing under wearing conditions (ergorama), as disclosed, for instance, in EP 1 830 222.

The computing type parameters may comprise, for instance, an indication that an optimization computing has to be performed or not, and a type of computing to be used for computing the optical lens. The type of computing and the optimization may in particular depend on the prescription and on the optical lens position in the range.

Frame parameters associated with the frame receiving the optical lens are, for instance, described in EP 1 830 222.

During the storing step S2, data related to the elements subsets SS₁, SS₂ and the associated properties collections PC₁, PC₂ are stored, for instance, in a database of the lens designer.

The elements subset related data aims at describing the elements subset SS₁, SS₂ from at least one primitive element PE. TABLE 1 shows examples of usable primitive elements PE.

TABLE 1

| Primitive | | | |
|---|---|---|---|
| element PE | Dimension | Definition | Syntax |
| Singleton | N | Coordinates of the | {(x₁,x₂,...,xₙ)} |
| | | singleton | |
| Ball | N | Coordinates of the center | Ball((x₁,x₂,...,xₙ),R) |
| | | Radius | |
| Parallelepiped | N | Coordinates of a vertex | Rect((x₁,..,xₙ),(y₁,...,yₙ)) |
| | | Coordinates of the | |
| | | opposite vertex | |
| Polygon | 2 | List of points (2 | <<(x¹₁,x¹₂),(x²₁,x²₂),...,(x^{m}₁−x^{m}₂)>> |
| | | coordinates) | |
| Convex | N | List of points or | <(x¹₁,...,x¹ₙ),(x²₁,...,x²ₙ),...,(x^{m}₁,...,x |
| polygon | | hyperplanes | ^{m}ₙ)> |
| Pixelated | 2 | List of points (2 | <<(x¹₁,x¹₂),(x²₁,x²₂),...,(x^{m}₁− |
| polygon | | coordinates) | x^{m}₂),step>> |
| | | Sampling step | |
| N-simplex | N | Coordinates of the vortex | Simplex((x¹₁,...,x¹ₙ),(x²₁,...,x²ₙ),..., |
| | | | (xⁿ⁺¹₁,...,xⁿ⁺¹ₙ)) |
| Interval | 1 | Coordinates of the ends | [xₘᵢₙ,xₘₐₓ] |
| Segment | N | Coordinates of the ends | [(x₁,...,xₙ),(y₁,...,yₙ)] |
| Grid | 1 | Coordinates of the ends | [[xₘᵢₙ,xₘₐₓ,step]] |
| | | Step | |

As indicated in TABLE 1, in the column ‘Dimension’, the usable primitive elements PE depend on the dimension of the elements subset SS₁, SS₂ to be described. Some primitive elements PE, as the singleton, may be used for any dimension N, but some primitive elements PE, as the polygon, may only be used for specific dimension, for instance N=2.

As indicated in TABLE 1, in the column ‘Definition’, each primitive element PE may be defined with few data in a frame associated with the space E by using a predefined syntax. The column ‘Syntax’ in TABLE 1 gives an example of usable syntax for defining the primitive elements PE.

According to some embodiments described herein, the elements subset related data describes the elements subset SS₁, SS₂ from a list of primitive elements PE and a list of set operators.

TABLE 2 shows examples of usable set operators.

TABLE 2

| Set Operators | Dimension | Parameters | Syntax |
|---|---|---|---|
| Union | N | 2 sets E₁, E₂ | E₁+E₂ |
| Intersection | N | 2 sets E₁, E₂ | E₁*E₂ |
| Cartesian | N | 2 sets E₁, E₂ | E₁**E₂ |
| product | | | |
| Rotation | N | 1 set E₁ | Rotate_E(E₁,i,angle) |
| | | Rotation axis | |
| | | Rotation angle | |
| Translation | N | 1 set E₁ | Translate_E(E₁,(x₁,...,xₙ)) |
| | | Translation vector | |
| Homothetic | N | 1 set E₁ | Homothetie_E(E₁,(x₁,...,xₙ)) |
| transformation | | 1 proportional | |
| | | transformation vectors | |
| Exclusion | N | 2 sets E₁, E₂ | E₁−E₂ |

As indicated in TABLE 2, in the column ‘Dimension’, the set operators may be used for any dimension N. The column ‘Syntax’ in TABLE 2 gives an example of usable syntax.

The sets E₁ and E₂ mentioned in TABLE 2 may designate a primitive element PE or any type of elements subset SS₁, SS₂. Indeed, depending on the complexity of the elements subset SS₁, SS₂ to be described, successive decompositions may be used for describing the elements subset SS₁, SS₂ from a list of primitive elements PE and a list of set operators. The steps S1 and S2 are then performed in a recursive way.

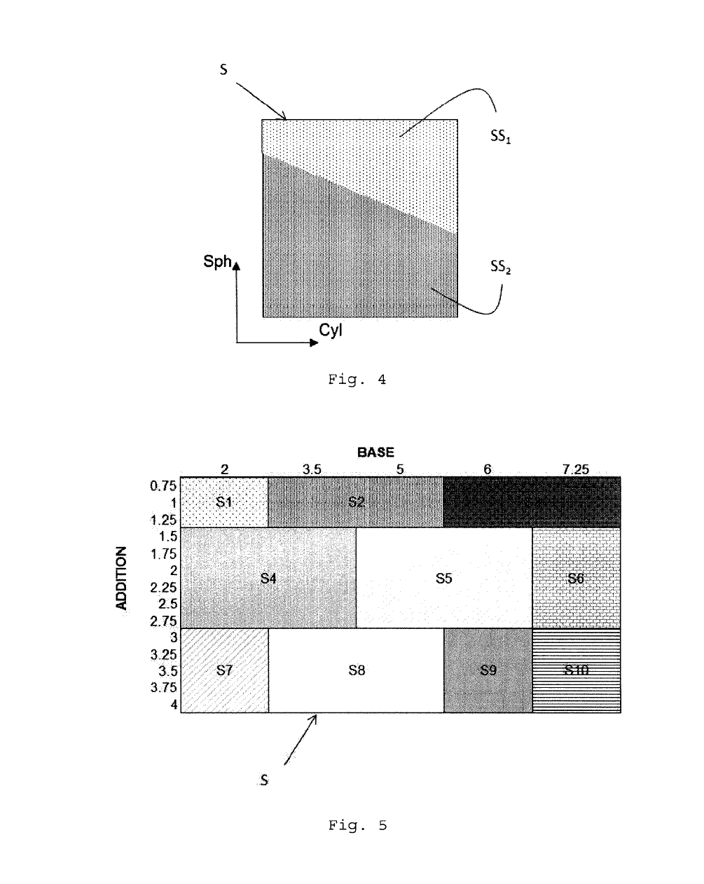

For instance, FIG. 3 represents an elements subset SS₃ to be described from a list of primitive elements PE and a list of set operators. During a first implementation of steps S1 and S2, the elements subset SS₃ is described from the intersection of an elements subset SS₄ and a convex polygon PE₁=<(0,−10),(6,−10),(6,−7.09),(0,−4.09)>.

Then, during a second implementation of the steps S1 and S2, the elements subset SS₄ is described from the Cartesian product of a grid PE₂[[0,6,0.25]] and a grid PE₃=[[−10,5.50,0.25]].

The elements subset SS₃ may thus be described from a list of primitive elements comprising a convex polygon and two grids, and a list of set operators comprising an intersection and a Cartesian product.

It is thus possible to decompose any complex elements subset SS₁, SS₂, SS₃, SS₄ into a list of primitive elements PE associated with set operators.

During the retrieving step S3, a request is used to retrieve some data for providing an optical lens.

According to some embodiments described herein, one or several elements subsets have to be retrieved from an element e_{E,x} of the space E with 1<x<M_{E}, M_{E} being an integer higher than 1.

Consider the example represented with FIG. 2. A request is received for retrieving one or several subsets SS₁, SS₂ containing the element e_{E,1}. As the element e_{E,1} is not belonging to the elements subset SS₁ nor to the elements subset SS₂, the response to this request is that no elements subset can be retrieved from this element e_{E,1}.

If a similar request is received for retrieving one or several subsets SS₁, SS₂ containing the element e_{E,2}=e_{S,1}, the retrieved elements subset is the elements subset SS₁. Several elements subsets SS₁, SS₂ may be retrieved from an element e_{E,x} when the element e_{E,x} is belonging to the several elements subsets SS₁, SS₂.

When an elements subset SS₁, SS₂ has been retrieved, the associated properties collection(s) PC₁, PC₂ may be retrieved from the stored elements subset data. For instance, the properties collection PC₁ may be retrieved from the stored elements subset data related to the elements subset SS₁.

According to other embodiments described herein, an elements subset SS₁, SS₂ has to be retrieved from the stored properties collection data. A received request here contained a list of properties P. It is then searched in the properties collection data for properties collection PC₁, PC₂ containing the list of properties P. Then, the associated elements subset(s) is(/are) retrieved. For instance, the properties collection PC₂ may be retrieved from the list of properties (P_{2,1}, P_{2,2}). Then the elements subset SS₂ may be retrieved from the properties collection data related to the properties collection PC₂. It has to be noted that the response to such a request may also be that no properties collection, or several properties collections, may be retrieved from the list of properties.

According to other embodiments, a properties collection PC₁, PC₂ has to be retrieved from the stored elements subset data. A received request here contained information related to an elements subset SS₁, SS₂, for instance, the elements subset SS₂. Then, the associated properties collection PC₂ is retrieved.

The below examples describe uses of the method.

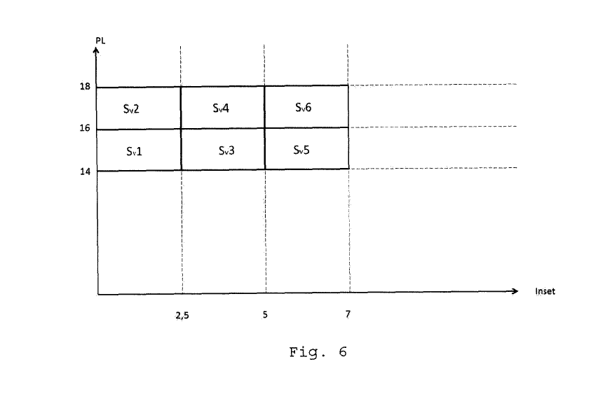

FIG. 4 represents a first example in which a 2-dimensional elements set S comprises elements e_{S,i}=(sph, cyl), where “sph” designates the spherical power, and “cyl” designates the cylindrical power.

During the determining step S1, a first elements subset SS₁ comprising elements e_{SS1,j}=(sph, cyl) is associated with a first properties collection PC₁ comprising a first property P_{1,1} and a second property P_{1,2}. The first property P_{1,1} indicates that the base curve data of the finished surface of a semi-finished lens is equal to a first value, for instance 5.25. The second property P_{1,2} indicates that the diameter data of the semi-finished lens is equal to a first value, for instance 70 mm.

A second elements subset SS₂ comprising elements e_{SS2,j}=(sph, cyl) is associated with a second properties collection PC₂ comprising a first property P_{2,1} and a second property P_{2,2}. The first property P_{2,1} indicates that the base curve data is equal to a second value, for instance 3.25. The second property P_{2,2} indicates that the diameter data is equal to a second value, for instance 65.

During the storing step S2, data related to the elements subsets SS₁, SS₂ and the associated properties collections PC₁, PC₂ is stored. The elements subset related data is describing the subsets SS₁, SS₂ from a list of primitive elements corresponding to primitive geometrical shapes (parallelepiped and polygon, for instance).

FIG. 5 represents a second example in which a 2-dimensional elements set S comprises elements e_{S,i}=(base, addition), where “base” designates the base curve data of the finished surface of a semi-finished lens, and “addition” designates the addition power.

Ten elements subsets are defined and respectively associated with ten properties collections, each properties collection containing one property corresponding to a particular semi-finished lens to be used among a list of usable semi-finished lens S₁ to S₁₀.

The method may then comprise a selecting step during which a semi-finished lens to be used for the optical lens is selected based on the retrieved properties collection.

Referring to FIG. 6, another example of use of the method according to embodiments is described. A method for providing an optical lens may require an attribution step during which a virtual lens surface is attributed for performing a lens calculation.

An attribution rule of the virtual lens surface may for instance specify that:
if 0.0<inset<2.5 then:
   if 14<progressive length (PL)<16 then first surface S_{V}1 has to be used for performing the lens calculation,
   if 16<progressive length<18 then second surface S_{V}2 has to be used for performing the lens calculation;
if 2.5<inset<5.0 then:
   if 14<progressive length<16 then third surface S_{V}3 has to be used for performing the lens calculation,
   if 16<progressive length<18 then fourth surface S_{V}4 has to be used for performing the lens calculation;
if 5.0<inset<7.0 then:
   if 14<progressive length<16 then fifth surface S_{V}5 has to be used for performing the lens calculation, and
   if 16<progressive length<18 then sixth surface S_{V}6 has to be used for performing the lens calculation.

Such attribution rules may become very complicated to manage when the number of parameters is increasing.

According to embodiments described herein, this attribution rule may be managed with an elements set S comprising elements e_{S,i}=(inset, length). Six elements subsets SS₁ to SS₆ are then defined and associated with properties collections PC₁ to PC₆, each properties collection PC₁ to PC₆ comprising one property indicating the virtual lens surface S_{V}1 to S_{V}6 to be used for performing the lens calculation.

The first subset SS₁ is described from a primitive element corresponding to a rectangle with four vertex V ₁ to V₄:

V₁=(inset=0.0; length=14)

V₂=(inset=0.0; length=16)

V₃=(inset=2.5; length=16)

V₄=(inset=2.5; length=14)

The first subset SS₁ is associated with a properties collection PC₁ containing one property indicating that the virtual lens surface S_{V}1 has to be used for performing the lens calculation.

The five other subsets SS₂ to SS₆ are described and associated with properties collections PC₂ to PC₆ in the same way.

Consequently, the number of data to be stored is reduced, and the data processing/retrieving is simplified.

According to embodiments described herein, the method may further comprise a calculating step during which the optical lens adapted to the wearer is calculated based on the retrieved properties collection, and/or a setting step during which machining parameters to be used for the optical lens machining are set based on the retrieved properties collection.

The invention has been described above with the aid of embodiments without limitation of the general inventive concept.

1. A method of data processing for providing an optical lens, the method being implemented by computer means and comprising:
a determining step during which an association between an elements subset of an elements set and a properties collection is determined, the elements subset comprising at least two elements, and
a storing step during which data related to the elements subset is stored at least as a stored elements subset data and the properties collection associated with the elements subset is stored at least as a stored properties collection data, the data related to the elements subset and describing the elements subset is from a list of primitive elements and a list of set operators.

2. The method according to claim 1, wherein the elements set belongs to an N-dimensional space, N being an integer, the method further comprising a retrieving step during which the elements subset is retrieved from an element of the N-dimensional space, the properties collection being retrieved from the stored elements subset data.

3. The method according to claim 1, further comprising a retrieving step during which one or more of the elements subset is retrieved from the stored properties collection data, and the properties collection is retrieved from the stored elements subset data.

4. The method according to claim 1, wherein the list of primitive elements comprises one or more elements selected at least from singleton, ball, parallelepiped, polygon, convex polygon, pixelated polygon, simplex, interval, segment, and grid.

5. The method according to claim 1, wherein the list of set operators comprises one or more elements selected at least from union, intersection, Cartesian product, rotation, translation, homothetic transformation, and exclusion.

6. The method according to claim 1, wherein the properties collection is related to at least one of the group selected from wearer parameters associated with a wearer of the optical lens, to lens parameters associated with the optical lens, to process parameters for manufacturing the optical lens, to target optical parameters for computing the optical lens, to environmental parameters associated with an environment of the wearer of the optical lens, to computing type parameters associated with a type of computing to be used for computing the optical lens, and to frame parameters associated with a frame receiving the optical lens.

7. The method according to claim 6, wherein the target optical parameters related to the properties collection comprise one or more properties selected from an inset of the optical lens, a progressive length of the optical lens, and a design feature of the optical lens.

8. The method according to claim 6, further comprising a selecting step during which a semi-finished lens to be used for the optical lens is selected based on properties collection retrieved in a retrieving step from stored properties collection data stored in the storing step.

9. The method according to claim 6, further comprising a calculating step during which the optical lens adapted to the wearer is calculated based on the properties collection retrieved in a retrieving step from stored properties collection data stored in the storing step.

10. The method according to claim 6, further comprising a setting step during which machining parameters to be used for the optical lens machining are set based on the properties collection retrieved in a retrieving step from stored properties collection data stored in the storing step.

11. The method according to claim 6, wherein the wearer parameters related to the properties collection comprise one or more properties selected from a reading distance of the wearer, a master eye of the wearer, a prescription data of the wearer, a positioning data of the optical lens relative to the wearer, and a physiological data of the wearer.

12. The method according to claim 8, wherein the lens parameters related to the properties collection comprise one or more properties selected from a base curve data of a finished surface of the semi-finished lens, a diameter data of the semi-finished lens, and a design data of the optical lens.

13. A computer program product stored on computer memory and executed on a processor that when used on computer apparatus causes the processor to carry out the steps of claim 1.

14. A non-transitory computer readable medium storing a computer program that when executed by a processor on a computer apparatus causes the processor to carry out one or more sequences of instructions of the computer program product of claim 13.

15. A data processing device for data processing to provide an optical lens, the data processing device comprising:
a non-transitory computer-readable medium; and
program instructions stored on the non-transitory computer-readable medium and executable by at least one processor to:
associate at least a first subset of elements of an elements set with a first properties collection, such that the first subset of elements comprises at least two elements;
store data related to the first subset of elements, such that the data related to the first subject of elements describes the first subset from a list of primitive elements;
store data related to the first properties collection associated with the first subset of elements;
retrieve the data related to the first subset of elements from the stored data related to the first properties collection;
retrieve the data related to the first properties collection from the stored data related to the first subset of elements;
calculate at least a portion of the optical lens using attribution rules and the retrieved data related to the first properties collection.

16. The data processing device according to claim 15, wherein the first properties collection comprises at least a first property and a second property.

17. The data processing device according to claim 15, wherein the attribution rules are based on the elements set.

18. The data processing device according to claim 15, wherein the primitive elements correspond to a primitive geometric shape.

19. The data processing device according to claim 15, wherein the first properties collection contains one property.

20. The data-processing device according to claim 15, further comprising at least one subset of elements, the at least one additional subset of elements associated with a second properties collection, such that the at least one additional subset of elements comprises at least two elements and the second properties collection contains one property.
